(19) United States
(12) Patent Application Publication
(10) Pub. No.: US 2022/0337423 A1
(43) Pub. Date: Oct. 20, 2022

(54) BLOCKCHAIN LEDGER-BASED AUTHENTICATION TECHNIQUES FOR REVIEWS

(71) Applicant: Murray Distributed Technologies, Inc., Madison, WI (US)

(72) Inventors: Connor Peter Murray, Mount Pleasant, SC (US); Dylan Terrence Murray, Wake Forest, NC (US)

(21) Appl. No.: 17/230,312

(22) Filed: Apr. 14, 2021

(51) Int. Cl. H04L 9/32; H04L 9/08; G06K 7/14

(52) U.S. Cl. CPC H04L 9/3247; H04L 9/0825; H04L 9/0861; G06K 7/1413; G06K 7/1417; H04L 2209/38

(57) ABSTRACT

Systems, methods, and techniques for providing blockchain ledger-based authentication for reviews. In one example, a system obtains an identifier associated with an event, generates a contract based on the event, and broadcasts the contract to a blockchain ledger. The contract is fulfilled in response to cryptographically authenticated user input. In another example, a user writes a review, determines conditions for access to the review, and provides the review to a system, in which the system generates a contract based on the review and the conditions, and broadcasts the contract to a blockchain ledger. Viewers can access the review by fulfilling the conditions for access to the review of the contract.

### CROSS REFERENCE TO RELATED APPLICATION(S)

This application is related to and incorporates by reference for all purposes the full disclosure of co-pending U.S. patent application Ser. No. ______ entitled “BLOCKCHAIN-BASED PRIVATE REVIEWS” (Attorney Docket No. 0116324-002US0), filed concurrently herewith.

### BRIEF DESCRIPTION OF THE DRAWING(S)

FIG. 1 illustrates an environment in which blockchain ledger-based tokenization techniques can be used to authenticate reviews, according to at least one embodiment;

FIG. 2 illustrates another environment in which blockchain ledger-based tokenization techniques can be used to authenticate reviews, according to at least one embodiment;

FIG. 3 illustrates a swim diagram relating to on-chain purchases, according to at least one embodiment;

FIG. 4 illustrates an environment in which private reviews can be implemented, according to at least one embodiment;

FIG. 5 illustrates an environment in which a private review can be generated, according to at least one embodiment;

FIG. 6 illustrates an environment in which a smart contract can be used to facilitate access to a private review, according to at least one embodiment;

FIG. 7 illustrates an example of a process to generate and process a smart contract, according to at least one embodiment;

FIG. 8 illustrates an example of a process to generate an authenticated review, according to at least one embodiment;

FIG. 9 illustrates an example of a process to generate a private review, according to at least one embodiment;

FIG. 10 illustrates an example of a process to view a private review, according to at least one embodiment;

FIG. 11 illustrates an example of a process to obtain contributions in connection with a private review, according to at least one embodiment; and

FIG. 12 is an illustrative, simplified block diagram of a computing device that can be used to practice at least one embodiment of the present disclosure.

### DETAILED DESCRIPTION

Techniques and systems described herein relate to techniques for providing blockchain ledger-based authentication for user-generated content, such as reviews of goods and services. In one embodiment, an actor performs one or more transactions in connection with a merchant system (referred to also as a “merchant”). The one or more transactions may include transactions corresponding to a purchase of goods and/or services from the merchant. The merchant may generate an identifier to be associated with the one or more transactions, and provide the identifier to a server system. The server system may generate a contract (e.g., a smart contract) using the identifier that may reward the actor for performing various actions in connection with the one or more transactions, such as leaving a review. The contract may be broadcast to a blockchain ledger, which may refer to a decentralized, distributed ledger that is used to immutably record transactions. The actor may perform the various actions in connection with the server system and the contract to cause the contract to be fulfilled and the reward to be dispensed to the actor.

In various embodiments, an author writes a review and determines conditions of access for the review. The conditions of access may include conditions such as a price for access to the review, or other actions required to access the review. The author may transmit the review to a server that may encrypt the review, and encode the encrypted review and the conditions of access in a contract. The contract may be broadcast to a blockchain ledger. Viewers may then access the review by satisfying the conditions of access, such as providing a contribution to one or more blockchain addresses. The contract may, upon satisfaction of the conditions of access, provide access to the review. The author may then obtain the contribution, or other data associated with satisfaction of the conditions of access.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described

Techniques described and suggested in the present disclosure improve the field of authentication, by providing a system that provides authentication for reviews and access to reviews using blockchain techniques. Additionally, techniques described and suggested in the present disclosure improve the security of reviews by providing cryptographic authentication for the reviews and access to the reviews. Moreover, techniques described and suggested in the present disclosure are necessarily rooted in computer technology in order to overcome problems specifically arising with providing cryptographically verifiable authentication of reviews and access to the reviews.

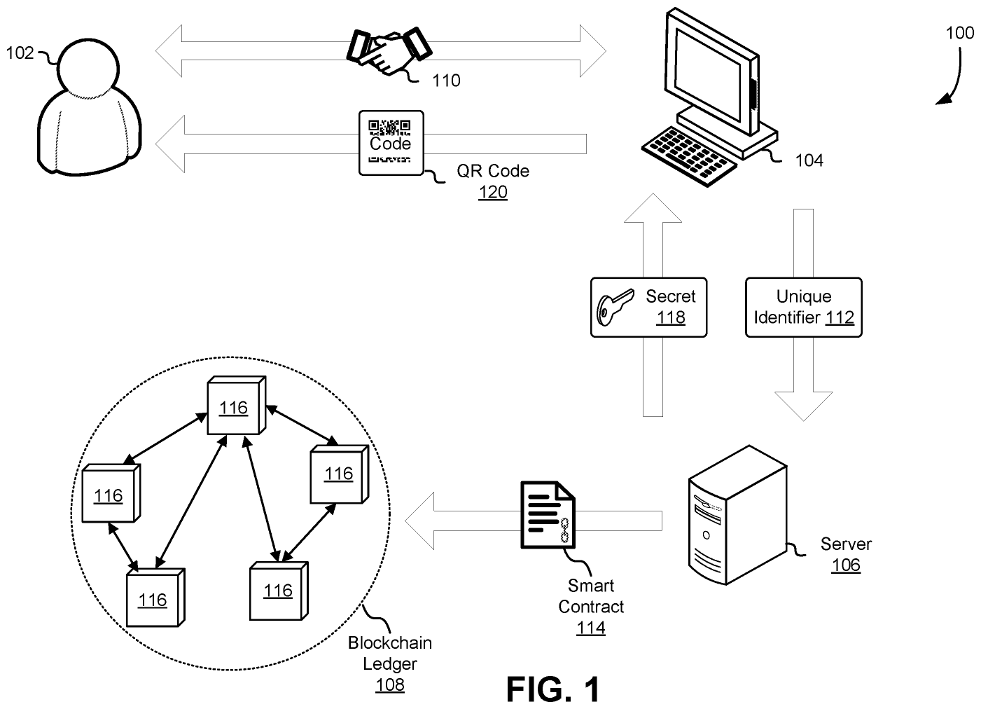

FIG. 1 illustrates an environment 100 in which blockchain ledger-based tokenization techniques can be used to authenticate reviews, according to at least one embodiment. As illustrated in FIG. 1, environment 100 may include an actor 102 as a first party, a merchant 104 as a second party, a server 106, and a blockchain ledger 108. For clarity, other parties which may be involved in this environment are omitted.

Environment 100 may describe at least one embodiment in which tokenization techniques are used to ensure the authenticity of an off-chain event (e.g., purchase of a good or service) and link the off-chain event to one or more blockchain transactions that are published to a blockchain ledger through a series of exchanges of data and information between several parties. Additionally, the blockchain ledger may be utilized to incentive parties to participate in certain activities through the exchange of control of digital assets according to smart contracts.

Actor 102, also referred to as an author or user, may refer to a consumer or purchaser of goods and/or services from a merchant 104. Actor 102 may have access to a computing device that has access to communications networks such as the Internet which can be used to communicate with computing entities in a remote manner, which will be described in more detail below. Actor 102 may have access to a computing device that has hardware and/or software for scanning QR codes. In some cases, QR code scanning software and/or hardware is not necessary, such as in embodiments where a website URL is used in place of a QR code. Actor 102 may perform various processes such as those described herein using one or more computing devices, such as a computer, tablet, mobile device (e.g., mobile phone), laptop, and/or variations thereof.

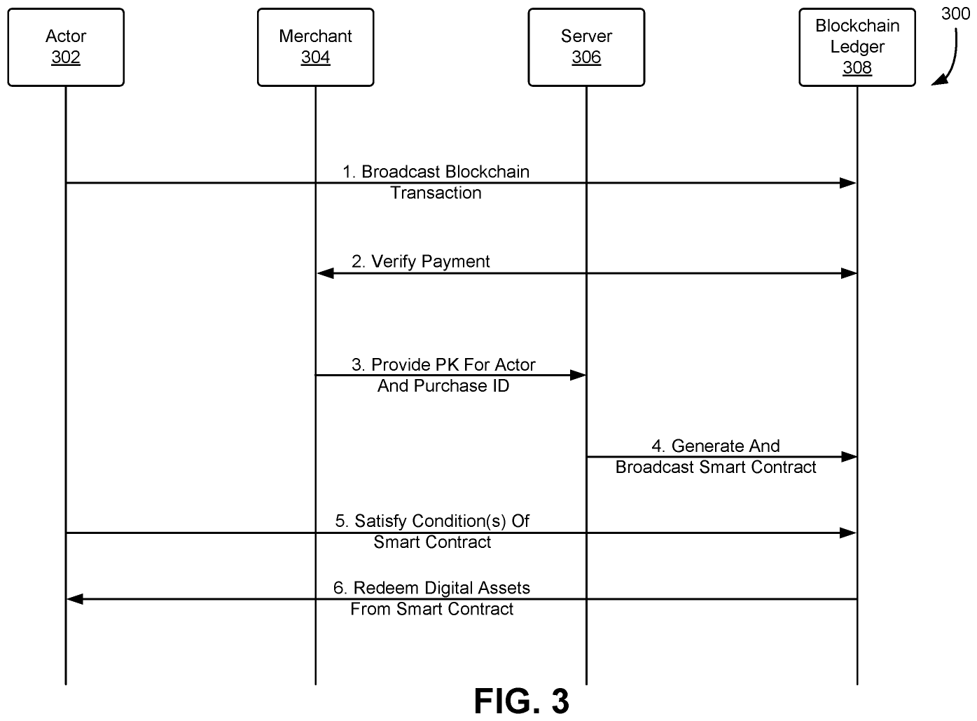

Merchant 104 may, likewise, refer to a merchant or seller of goods and/or services that can provide exchanges in any suitable manner. For example, exchanges can be performed off-chain, on-chain, or a combination thereof. An off-chain transaction may refer to a “traditional” transaction which does not involve the use of a blockchain ledger—for example, actor 102 tenders something of value (e.g., fiat currency) in exchange for a good and/or a service from merchant 104. An on-chain transaction may refer to a transaction done in connection with a blockchain ledger, as described in further detail in connection with FIG. 3. Off-chain transactions may, nevertheless, still involve the use of computer systems—for example, if payment is made through the use of a credit card or debit card, this off-chain exchange may involve the merchant using a payment terminal to contact a payment network, and complete the transaction through the use of the payment network, which may perform various checks to ensure the propriety of the transaction, such as verifying that the purchaser has sufficient credit or balances to cover the amount to be paid, verifying authorization to make a payment by requiring the purchaser enter a secret code (e.g., a PIN code) which is only known by actor 102, and more. Merchant 104 may be implemented using one or more computer systems accessible to an actor 102. Actor 102 may interact with merchant 104 remotely, such as through the Internet, or physically, such as through a physical computer terminal in a physical location of the merchant 104.

An off-chain event 110 may refer to the occurrence of a real-world event which is linked to an on-chain smart contract using techniques described in this disclosure. Off-chain event 110 may be a real-world event involving both the actor 102 and the merchant 104. For example, off-chain event may encode a transaction between actor 102 and merchant 104. Generally speaking, any suitable off-chain event can form the basis of off-chain event 110, including the performance of a series of events, an agreement between two parties, agreement between multiple parties, and so on. In some cases, an off-chain event is a unilateral event that occurs with the participation of only one party—for example, if merchant 104 wants to send a promotion or reward token to actor 102, an agreement between the parties may not be necessary. Off-chain events may be tokenized and broadcast to a blockchain ledger using a smart contract to provide assurances of authenticity, integrity, non-repudiation (or various combinations thereof) of subsequent data that is published to the blockchain ledger, such as reviews linked to the purchase of goods or services that are the basis of the off-chain event 110.

Upon occurrence of an off-chain event 110, merchant 104 may generate a unique identifier 112 that is associated with the off-chain event 110. Unique identifier 112 may, for example, be a transaction identifier generated by a payment network or any other suitable identifier that is either guaranteed to be unique or sufficiently unique. Examples of unique or sufficiently unique identifiers include a universally unique identifier (UUID) or globally unique identifier (GUID). An identifier may be generated by a merchant's computer system which is, for practical purposes, unique. While the identifier is described to be unique, it does not necessarily need to be globally unique, but should encode enough information that the identifier can be resolved to a specific off-chain event. For example, a merchant can use a monotonically increasing number for each transaction processed in a day (e.g., starting from 1 for the first transaction of the day, 2 for the second transaction of the day, and so on) and unique identifier can be generated from a tuple of information that includes the transaction number, the date of the transaction, and a unique value associated with the merchant. Identifiers may be pre-generated or pre-computed for convenience, or may be dynamically generated as a result of or in response to the occurrence of the off-chain event 110.

In some cases, the unique identifier 112 can be jointly generated by actor 102 and merchant 104—for example, unique identifier 112 may have a plurality of portions such that a first portion is provided by merchant 104 (e.g., as described above) and a second portion is provided by actor 102. Each portion may be sufficiently unique such that it can be linked to off-chain event 110 and/or the particular party that is supplying the portion of the unique identifier 112. Using a unique identifier 112 with multiple portions can be used as a form of non-repudiation, such that each party that supplies a portion of the unique identifier provides a cryptographically verifiable assurance that the particular party attests to the occurrence of the off-chain event in a way that cannot be subsequently denied or repudiated by that party. Cryptographic techniques such as those that can be used to generate MAC tags, digital signatures, hashes, etc. can be used in the generation of unique identifier 112 or portions thereof.

Merchant 104 may provide unique identifier 112 to server 106. Server 106 may be implemented as software, hardware, or a combination. A web-based application programming interface (API) call may be utilized for communications between merchant 104 and server 106. For example, a web API command can be submitted by merchant 104 to server 106 to create smart contract 114 and bind it to off-chain event 110 using unique identifier 112.

Server 106 may be one or more computer systems that provide a web-based platform that is used by merchants to incentive more reviews, earn incentives and tokenized rewards for good reviews, and ensure the authenticity of reviews. Server 106 may leverage a blockchain ledger as a smart contract and tokenization platform to create and broadcast interactive data objects on the blockchain. One way in which the blockchain ledger can be utilized is to create immutable data objects on the blockchain which cannot be altered once they are created. For example, a user can create a review, and this review cannot be altered by another party, such as the merchant or review platform. In some cases, immutability does not mean that the object cannot be updated by the user—for example, a user may post a review which is digitally signed by a private key that the user controls and then later amend or update the review using the same private key by creating a subsequent data object that references the original review and encodes updates or addendums to the original review. If the user retains the secrecy of this private key, other parties such as the merchant or platform do not have the ability to alter the original review or update the review as any attempt to create such data objects without cryptographic material that is generated using the secret key would be rejected by the blockchain ledger.

Server 106 may use unique identifier 112 to create a smart contract 114 that is associated or otherwise bound to off-chain event 110 previously discussed above. Smart contract 114 may be an example of a type of interactive data object that can be created and broadcasted to blockchain ledger 108. Smart contract 114 may be an interactive data object that actor 102 can interact with. Server 106 may use smart contract 114 to encumber a transfer of control of digital assets with a set of conditions. These conditions can be used to incentivize actor 102. For example, server 106 may create smart contract 114 that transfers control of digital assets such as Bitcoins, colored coiners, or other types of digital assets to actor 102 on a condition that actor 102 writes a review for merchant 104, etc. The smart contract 114 may reference the unique identifier 112, which associates a specific smart contract (e.g., smart contract 114 shown in FIG. 1) to a specific off-chain event (e.g., off-chain event which uniquely maps on to unique identifier 112). While only one smart contract is illustrated in FIG. 1, there may be a multitude of smart contracts corresponding to a multitude of off-chain events in a one-to-one relationship.

Various cryptographic techniques may be used to create a smart contract 114 that prevents unrelated parties from interacting with the smart contract. Even though smart contract 114 may be published on a public ledger that is accessible to the general public, smart contract 114 may require the use of specific cryptographic key or secret. For example, when smart contract 114 is created, server 106 may also create or otherwise obtain a cryptographic key pair comprising a private key and a public key. The smart contract 114 may be written to include a public key such that when a purported review is broadcast to the blockchain network, in order for the smart contract to be successfully executed, a digital signature over the purported review must be validated using the public key encoded in the smart contract. Accordingly, unrelated parties are unable to cause execution of the smart contract because they lack access to the private key that would be used to generate the digital signature and therefore the validation check would fail. The private key may be a secret, such as secret 118 illustrated in FIG. 1. Smart contract may encode various information such as unique identifier 112, conditions that encumber the transfer of digital assets (e.g., from a blockchain address controlled by server 106 to actor 102), a public key that is to be used to validate execution of the smart contract, and so on.

In an embodiment, a smart contract is executable code that runs on a blockchain to facilitate, execute, and/or enforce various terms of a contract or agreement. A smart contract may be a machine executable program which comprises rules that can process inputs in order to produce results, which can then cause actions to be performed dependent upon those results. Code of a smart contract may be stored, verified, and executed on a blockchain.

Smart contract 114 may be broadcast to blockchain ledger 108. Smart contract 114 may be transmitted or otherwise broadcast to blockchain ledger 108 as a transaction that includes code for the smart contract 114 and/or one or more addresses indicating the smart contract 114. Blockchain ledger 108 may be in reference to an example blockchain network associated with a blockchain in accordance with an embodiment of the present disclosure. A blockchain network may implement a distributed ledger; the distributed ledger implemented by the blockchain network may be referred to as a blockchain ledger, or more generally as a blockchain. In an embodiment, an example blockchain network comprises peer-to-peer distributed electronic devices each running an instance of the blockchain protocol. In some examples, the distributed electronic devices are referred to as nodes. An example of a blockchain protocol is a Bitcoin protocol.

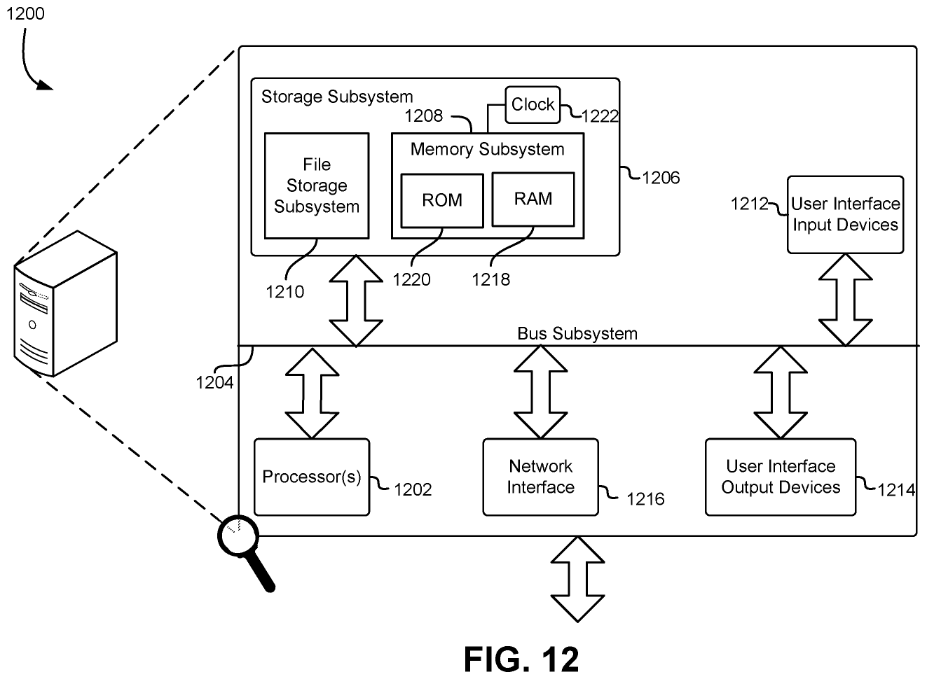

FIG. 1 illustrates, in accordance with at least one embodiment, several nodes 116. Nodes may be remote nodes or local nodes. The nodes may be comprised of any suitable computing device (e.g., by a server in a data center, by a client computing device (e.g., a desktop computer, laptop computer, tablet computer, smartphone, etc.), by multiple computing devices in a distributed system of a computing resource service provider, or by any suitable electronic client device such as the computing device 1200 of FIG. 12). A local node may refer to a node of the blockchain network that is implemented on computing resources owned, accessible, and/or otherwise under the control of a particular party, such as server 106.

In an embodiment, one or more of the nodes 116 are communicatively coupled to one or more other of the nodes 116. Such communicative coupling can include one or more of wired or wireless communication. In an embodiment, the nodes 116 each maintain at least a portion of a ledger of all transactions in the blockchain. In this manner, the ledger is a distributed ledger. A transaction processed by a node that affects the ledger is verifiable by one or more of the other nodes such that the integrity of the ledger is maintained.

In an embodiment, at least some of the nodes 116 are miner nodes that perform complex calculations, such as solving cryptographic problems. A miner node that solves the cryptographic problem may create a new block for the blockchain and broadcast the new block to others of the nodes. The others of the nodes may verify the work of the miner node and, upon verification, accept the block into the blockchain (e.g., by adding it to the distributed ledger of the blockchain). In some examples, a block is a group of transactions, often marked with a timestamp and a “fingerprint” (e.g., a hash) of the previous block. In this manner, each block becomes linked to a previous block, thereby creating the “chain” that links the blocks in the blockchain. In embodiments, valid blocks are added to the blockchain by a consensus of the nodes. In some examples, a blockchain comprises a list of validated blocks.

In an embodiment, at least some of the nodes 116 operate as validating nodes that validate transactions as described in the present disclosure. In some examples, a transaction includes data that provides proof of ownership of a digital asset (e.g., a number of Bitcoins) and conditions for accepting or transferring ownership/control of the digital asset. In some examples, a “spending transaction” refers to a transaction that reassociates (e.g., transferring ownership or control) at least a portion of a digital asset, indicated by an unspent transaction output (UTXO) of a previous transaction, to an entity associated with a blockchain address. In some examples, a “previous transaction” refers to a transaction that contains the UTXO being referenced by the spending transaction. In some embodiments, the transaction includes a “locking script” that encumbers the transaction with conditions that must be fulfilled before ownership/control can be transferred (“unlocked”). In some embodiments, the blockchain address is a string of alphanumeric characters that is associated with an entity to which control of at least a portion of a digital asset is being transferred/reassociated. In some blockchain protocols implemented in some embodiments, there is a one-to-one correspondence between a public key associated with the entity and the blockchain address. Validation of transactions may involve validating one or more conditions specified in a locking script and/or unlocking script. Upon successful validation of the transaction, the validation node may add the transaction to the blockchain and distribute it to the nodes.

Another area of blockchain-related interest may be the use of “tokens” (or “colored coins”) to represent and manage the transfer of real-world assets via the blockchain. A potentially sensitive or secret item can be represented by the token which may have no discernible meaning or value. The token thus may serve as an identifier that allows the real-world item to be referenced from the blockchain. Tokens may be implemented by encoding metadata within scripts of a blockchain transaction to represent asset manipulation instructions. For example, real-world value may be attached to digital tokens by an asset issuer's assurance to redeem some goods or services. For example, a merchant of baked goods may issue tokens to customers upon completion of a purchase, submission of an online review, and the like. For example, the merchant may issue tokens for each purchase, and upon the collection of a certain number of tokens, allow the purchaser to redeem a plurality of tokens in exchange for a reward.

Broadcasting a smart contract 114 to a blockchain ledger 108 (e.g., via a transaction comprising code for the smart contract 114) may result in various technical properties. A smart contract 114 stored on a blockchain may be immutable, which may refer to a property of the smart contract 114 in which contents of the smart contract 114 may not be changed or otherwise altered without validation from nodes of the blockchain. A review published to a blockchain ledger 108 (e.g., via a transaction) in connection with a smart contract 114 may also be immutable. A blockchain ledger 108 may be publicly accessible, in which terms and other information of a smart contract 114 and/or a review may be publicly accessible or otherwise viewable. Use of a blockchain ledger in connection with smart contracts, reviews, and the like may provide a publicly provable record of authenticity of various smart contracts, reviews, and the like stored within the blockchain ledger.

Secret 118 may refer to a private key of an asymmetric cryptographic key pair. In some cases, server 106 dynamically generates key pairs for smart contracts when it receives unique identifier 112. In some cases, existing cryptographic keys may be used. For example, server 106 may host a website in which actor 102 is given the option to create an account with server 106. The account may be associated with a key pair, which can be used to generate smart contract 114. Secret 118 may be any suitable cryptographic secret, such as a cryptographic hash, string, sequence of characters, and the like.

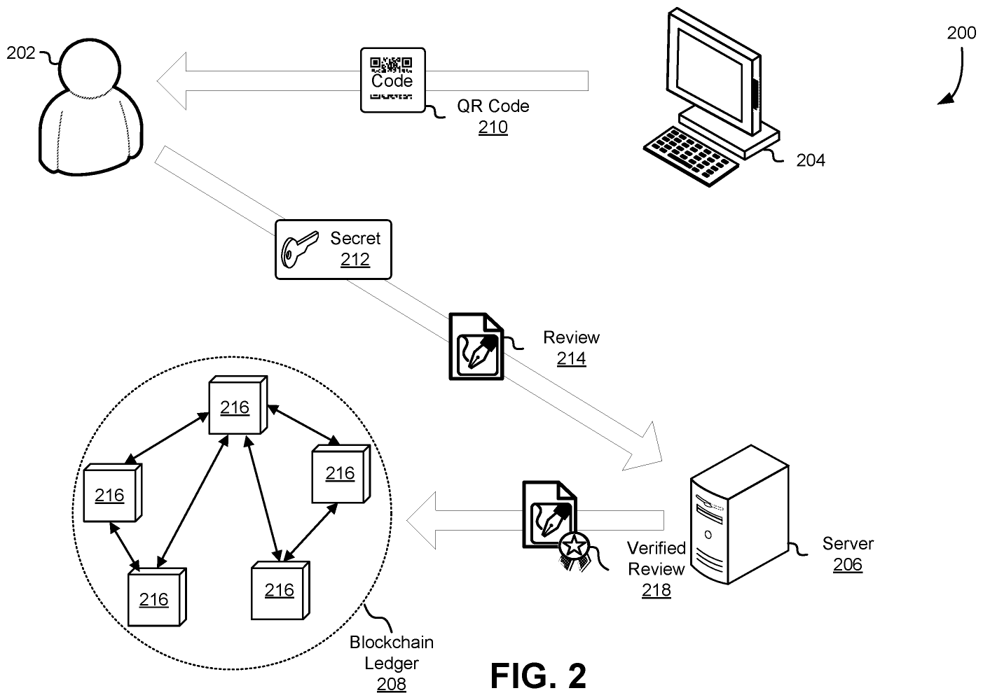

Secret 118 may be transmitted to merchant 104 and then encoded in a quick response (QR) code 120 that is then provided to actor 102. While FIG. 1 illustrates a QR code 120, any suitable code may be utilized, such as a QR code, barcode, sequence of alphanumeric characters, and the like. Other data may also be utilized in place of a QR code, such as a unique URL or other suitable identifier. QR code 120 may encode a web link (e.g., URL) or other identifier that actor 102 may scan with a computing device (e.g., a mobile device) to bring up or otherwise access or obtain a webpage or other interface (e.g., software application) that may prompt the actor 102 to write a review, sign up for a mailing list, or other behavior. In some cases, secret 118 is encrypted using a different secret that is only accessible to actor 102 (e.g., using asymmetric key cryptography) so that there are cryptographically verifiable assurances of confidentiality that prevent merchant 104 from accessing secret 118 or otherwise interacting with smart contract 114 in an unintended manner. Once actor 102 receives QR code 120, techniques described in connection with FIG. 2 may be practiced.

FIG. 2 illustrates an environment 200 in which blockchain ledger-based tokenization techniques can be used to authenticate reviews, according to at least one embodiment. As illustrated in FIG. 2, environment 200 may include an actor 202 as a first party, a merchant 204 as a second party, a server 206, and a blockchain ledger 208. These may be the same or substantially similar to those described elsewhere in this disclosure, such as those discussed in connection with FIG. 1. For clarity, other parties which may be involved in this environment are omitted.

Environment 200 may describe at least one embodiment in which tokenization techniques are used to ensure the authenticity of an off-chain event (e.g., purchase of a good or service) and link the off-chain event to one or more blockchain transactions that are published to a blockchain ledger through a series of exchanges of data and information between several parties. Additionally, the blockchain ledger may be utilized to incentive parties to participate in certain activities through the exchange of control of digital assets according to smart contracts.

Quick response (QR) code 210 illustrated in FIG. 2 may be generated according to techniques discussed above in connection with FIG. 1. As previously discussed, QR code 210 may encode secret 212 and/or other information. While FIG. 2 illustrates a QR code 210, any suitable code may be utilized, such as a QR code, barcode, sequence of characters, or any suitable code. In some cases, QR code 210 is generated by merchant 204 using information provided by server 206, as in the various embodiments discussed in connection with FIG. 1. QR code 210 may encode the secret 212 in a plaintext format (e.g., as part of a URL that can be scanned to bring actor 202 to a website to write a review) or in an encrypted format that can be decrypted using a cryptographic key (e.g., asymmetric private key or symmetric secret key) that actor 202 has access to. In some embodiments, QR code 210 is printed on a receipt that corresponds to a purchase that actor 202 made and for which the review is being solicited for. Actor 202 can use a mobile device or other suitable computing device to scan QR code 210

Actor 202 may extract, decrypt, or otherwise obtain secret 212 from QR code 210. Actor 202 may utilize various QR code scanning software and/or hardware to extract secret 212 from QR code 210. In some examples, actor 202 derives information from QR code 210 (e.g., via various code scanning software and/or hardware) and determines secret 212 based on the derived information, such as through a key derivation function, cryptographic cipher, or other suitable process. In various embodiments, actor 202 utilizes QR code 210 to obtain or otherwise access a software application or other interface, such as a mobile phone application, website, or any suitable computing interface, that encodes or otherwise stores secret 212. The secret 212 can be used by actor 202 to interact with a blockchain data object, either directly or indirectly. For example, as illustrated in FIG. 2, actor 202 can interact with blockchain ledger 208 in an indirect manner by providing secret 212 and review 214 to server 206. The secret 212 and/or review 214 can be provided in a confidential manner, such as through the submission of the review through a HTTPS website. In some embodiments, server 206 verifies the secret 212 is correct (e.g., matches a corresponding transaction identifier that is provided) and executes a smart contract by publishing verified review 218 to blockchain ledger 208.

Review 214 may be a review written by actor 202 but in other cases can represent other actions which may be incentivized. For example, QR code 210 may be used to incentivize actor 202 to sign up for a newsletter, a loyalty program, or other behaviors, and the user may be rewarded for performing such a task in a manner specified by a smart contract. The rewards may be distributed by server 206.

Server 206 may coordinate publication of verified reviews. Actor 202 may send to server 206 a review 214, secret 212, and information indicating a transaction or other off-chain event that the review is being submitted for. In some examples, actor 202 sends server 206 a review 214 and secret 212 by accessing an interface (e.g., an application, computer program, or website) via QR code 210 that encodes or otherwise stores the secret 212, and inputting the review 214 into the interface, in which the interface sends the secret 212 and the review 214 to the server 206. In some cases, actor 202 causes an interface to send secret 212 to server 206, and provides review 214 separately. In various embodiments, actor 202 extracts secret 212 via QR code 210, and provides the secret 212 and review 214 to server 206.

Server 206 may receive a review 214, secret 212, and other information and use them to identify a specific smart contract. A unique identifier such as those described in FIG. 1 can be used to identify a specific smart contract. Verified review 218 may be generated using review 214 and secret 212. Secret 212 may be used to provide an attestation that actor 202 generated the review 214, as it may be the case that only actor 202 has access to secret 212. Even in cases where middlemen such as merchant 204 may have (temporary) access to secret 212, it may be acceptable, as the merchant's generation of fraudulent reviews (e.g., by pretending to be the reviewer) may be harmful to the merchant's reputation and/or may result in the merchant being penalized or removed from the platform that server 206 operates.

Server 206 may generate verified review 218. Verified review 218 may be generated by server 206 using both secret 212 and review 214. Server 206 may generate verified review 218 by digitally signing review 214 with the secret 212 or cryptographic key associated with the secret 212. A cryptographic key may be associated with the secret 212 such that the cryptographic key can be extracted from the secret 212, such as through one or more key derivation functions or the like. In some examples, actor 202 may generate verified review 218. Actor 202 may obtain secret 212 from QR code 210, and generate verified review 218 by digitally signing review 214 with the secret 212 or cryptographic key associated with the secret 212. Actor 202 may provide verified review 218 to server 206.

Verified review 218 may be published to blockchain ledger 208 as a blockchain transaction that includes review 214, references a previously published smart contract, and/or encodes either secret 212 or cryptographic material generated by secret 212 (e.g., a digital signature) that provides a cryptographically verifiable attestation that the entity publishing the blockchain transaction knows the secret 212. For example, a transfer of digital assets in a smart contract (e.g., an incentive for writing a review) may be encumbered on a condition that a review for the transaction is published and is signed using a specific private key corresponding to a public key (e.g., encoded in the smart contract). The private key may be secret 212, and verified review 218 may include review 214 digitally signed using the secret 212.

Verified review 218 may be published to blockchain ledger 208 and cause the execution of the smart contract (e.g., execution of code of the smart contract). Execution of a smart contract may be completed by transferring control of digital assets to actor 202. Control can be transferred in various ways. For example, if actor 202 has a blockchain wallet, control of digital assets may be granted to the actor's wallet. In some cases, secret 212 is used to initiate a transfer of control of the digital assets to another party different from the actor 202—for example, the digital assets encumbered by the smart contract may be used to pay merchant 204 in a subsequent purchase.

FIG. 3 illustrates a swim diagram 300 relating to on-chain purchases, according to at least one embodiment. In at least one embodiment, actor 302, merchant 304, server 306, and blockchain ledger 308 may be parties or entities as described in connection with FIG. 1. In FIG. 3, actor 302 may have a blockchain digital wallet and control of digital assets which can be used for various types of exchanges. As illustrated in FIG. 3, smart contracts can be generated to incentivize certain behaviors in relation to on-chain events. In this case, the on-chain event may refer to actor 302 broadcasting a blockchain transaction to blockchain ledger 308 (e.g., to make a payment). An on-chain event or transaction may refer to an actor 302 broadcasting a blockchain transaction to blockchain ledger 308 to obtain one or more goods and/or services from a merchant 304.

In at least one embodiment, merchant 304 verifies that the payment was received (e.g., blockchain transaction of step 1 is a transfer of control of digital assets from actor 302 to merchant 304). Upon verifying that the payment was made, merchant 304 may provide a good or service in exchange for being granted control to the digital assets referenced in the transaction. Merchant 304 may generate a purchase ID (e.g., a unique identifier as discussed in connection with FIG. 1) and then provide the purchase ID and the public key associated with the actor's wallet.

Server 306 may generate a smart contract using the public key of the actor and the purchase ID. The purchase ID may be the transaction ID of the blockchain transaction referenced in step 1. In some embodiments, the server 306 encrypts a secret using the public key of the actor and then that ciphertext is encrypted using a second key to create a doubly-encrypted secret. The outer layer of encryption may be decrypted when a condition of the smart contract is fulfilled, such as when a subsequent review for the transaction is broadcasted to the blockchain ledger. The inner layer of encryption can then be decrypted by actor 302 at any time using its private key to reveal the secret. The secret may then be used to redeem or transfer control of the underlying digital assets of the smart contract. For example, the secret can be utilized to access digital assets associated with one or more blockchain wallets corresponding to the secret.

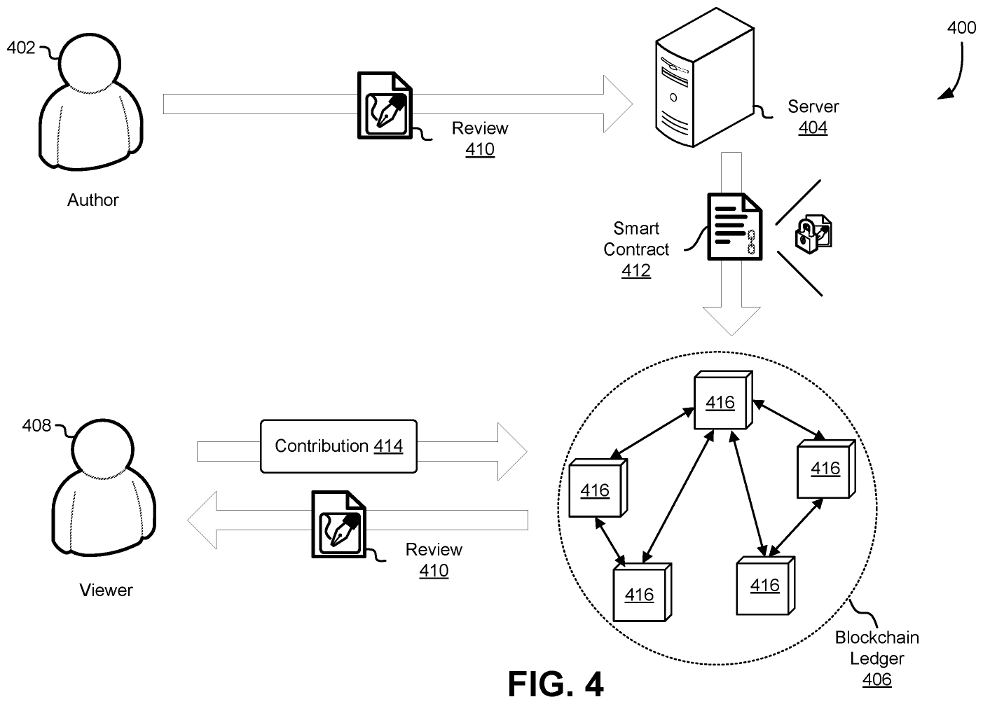

FIG. 4 illustrates an environment 400 in which private reviews can be implemented, according to at least one embodiment. As described in greater detail below, smart contracts described herein can be used to tokenize access to tokens that are published on a blockchain ledger. Environment 400 may include an author 402, server 404, blockchain ledger 406, and viewer 408. These entities may be the same or similar to those discussed in other figures, such as FIG. 1.

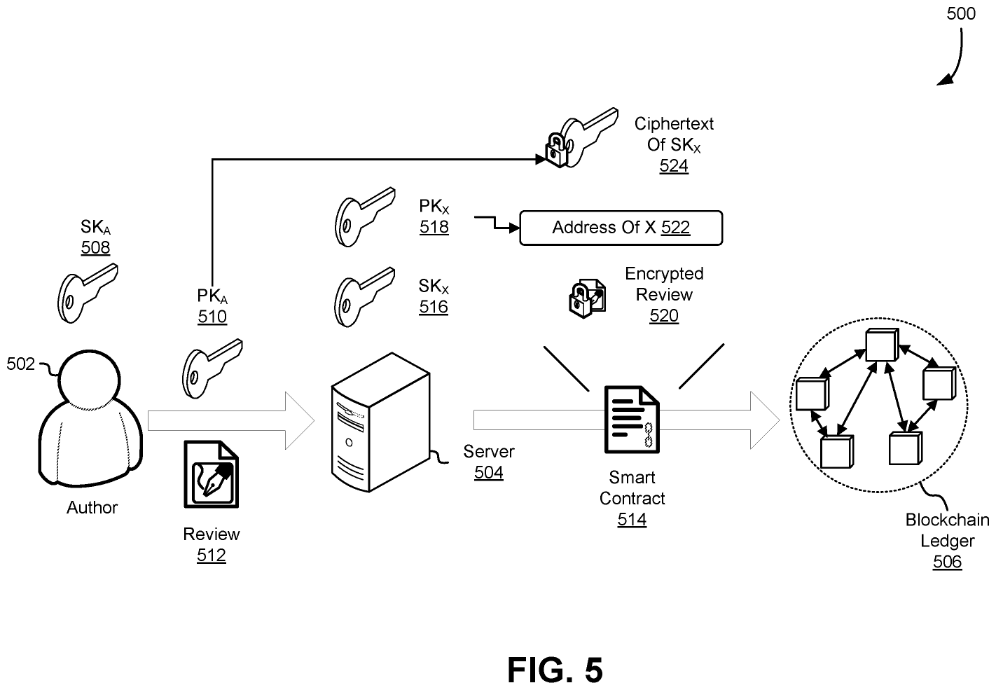

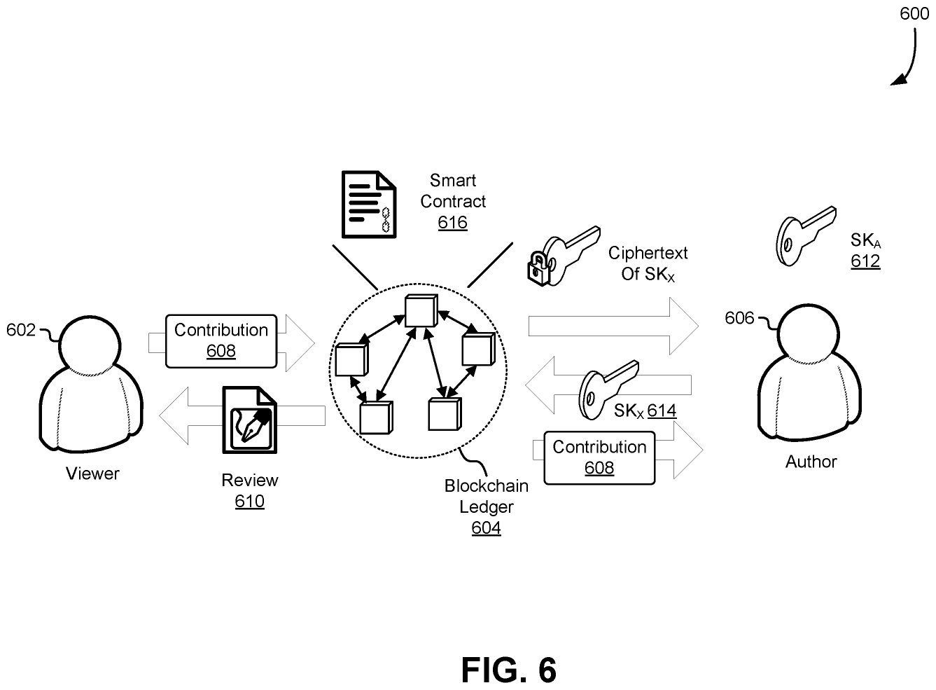

FIG. 4 illustrates various aspects of private reviews, which may be discussed in greater detail below in connection with FIGS. 5 and 6. Author 402 may refer to a computing entity controlled by the author of a review or other information which author 402 may have rights to, including but not limited to written, audio, photo, and video based works. For illustrative purposes, FIG. 4 discusses author 402 in the context of a review that is written by author 402. Techniques described in connection with FIGS. 1-3 can be utilized to ensure that reviews are authentic.

Author 402, also referred to as an actor or user, may write a review and send it to server 404, which may be the same or similar to servers described above. Author 402 may include additional information and/or conditions regarding how the review is to be privatized and distributed such as, for example, setting a price on access to the review, providing a preview or description of the review that is to remain public, and any number of other conditions on access to the review. Server 404 may generate a smart contract 412 that may be broadcast to blockchain ledger 406, which can be accessible to nodes of a public blockchain network. Smart contract 412 may encode an encrypted or private version of review 410 such that it is not possible to directly view the contents of review 410 from the data written to the blockchain ledger 406. Instead, smart contract 412 may encode the conditions and rules for accessing the review. For example, viewer 408 may be required to make a transfer of digital assets (e.g., payment of specified amount of Bitcoins) to a particular wallet address in order to receive access to the review. Contribution 414 may refer generally to data or other information that is broadcast to blockchain ledger 406 to satisfy one or more conditions encoded in smart contract 412 for access to review 410. A contribution may include control of one or more digital assets, such as cryptographic tokens. Contribution 414 may be used to cause execution of the smart contract 412, which may include, for example, granting tokenized access to review 410 so that viewer 408 is able to read or otherwise access the review 410.

FIG. 5 illustrates an environment 500 in which a private review can be generated, according to at least one embodiment. Environment 500 may involve author 502 (e.g., computing device controlled by the author), server 504, and blockchain ledger 506, which may be in accordance with those described elsewhere, such as in connection with FIG. 4.

Author 502 may have access to a private key SK-A 508 with a corresponding public key PK-A 510. The private key may be any suitable secret that author 502 has access to. In some cases, public key 510 is derived from private key 508. Author 502 may create review 512 and provide the review 512 and public key PK-A 510 to server 504 using any suitable mechanism. Other information may be provided by author 502 to server 504, such as a price to set on the review, a preview or description of the review which may be publicly accessible, a total quantity of tokens to vend, and any other such conditions on access to the review.

Server 504 may receive public key PK-A 510 and review 512 and generate smart contract 514. Smart contract 514 can be used to gate or condition access the review 512 to prevent unauthorized access or distribution. Various implementations are described in greater detail below.

Server 504 may generate or otherwise obtain an asymmetric key pair comprising a public key PK-X 518 and private key SK-X 516. These may be used to facilitate generation of the smart contract 514 and protect access to review 512. Encrypted review 520 may be encrypted using public key PK-X 518 or any other suitable key to prevent access to review 512 without use of a corresponding cryptographic secret. In some cases, encrypted review 520 relies on a M-of-N scheme in which multiple private keys may be needed. In one example, a 2-of-2 scheme is used in which server 504 holds one of the keys and the other key is provided in exchange for a transfer of control of digital assets (e.g., Bitcoins). Server 504 may maintain a blacklist of banned blockchain addresses which should not be granted access to reviews—for example, due to poor past behavior such as leaking of previous review or other prohibited behavior. For all other addresses, server 504 may readily contribute its key. Encrypted review 520 may be included or otherwise encoded in smart contract 514.

In some cases, the encrypted review is not included in smart contract 514, for example, to reduce the size of the smart contract 514. Server 504 can store review 512 using a suitable data storage device and act as a host for reviews. A hash of review may be included in smart contract 514. Hash of review 520 may be generated using any suitable hashing function or one-way function. Hash of review may be generated by hashing the entire review 512 and can be used to validate that a review that is subsequently provided by server 504 is indeed the review linked to smart contract 514. Address 522 may refer to a wallet address which is to be paid for access to the review. In some cases, address 522 is the public key PK-X 518, but it can also be generated based on public key PK-X 518 or can even be an unrelated wallet address. Ciphertext of private key SK-X 524 may also be encoded in smart contract 514. The ciphertext may be generated using public key PK-A 510 which can be decrypted using private key SK-A 508. Encrypting private key SK-X 516 to determine ciphertext of private key SK-X 524 of smart contract 514 using the author's key pair PK-A/SK-A may effectively link the smart contract 514 and the key pair PK-X/SK-X to the author 502.

FIG. 6 illustrates an environment 600 in which a smart contract can be used to facilitate access to a private review, according to at least one embodiment. Embodiments in FIGS. 5 and 6 may be utilized in conjunction with each other to publish and distribute private reviews. Viewer 602, blockchain ledger 604, and author 606 may be coextensive with those described elsewhere in this disclosure, such as those discussed in connection with FIGS. 4 and 5. Environment 600 may arise subsequent to the publishing of a private review—for example, as a result of performing techniques described in FIG. 5.

Viewer 602 may refer to a user or computing device controlled by a user that wishes to gain access to a private review. Smart contract 616 may have been broadcasted to blockchain ledger 604 such that a private review can be accessed, subject to conditions. For example, a condition may be satisfied by the viewer 602 providing contribution 608 to blockchain ledger 604. Contribution 608 may refer to the control of digital assets, and may be transmitted from viewer 602 via one or more transactions to a blockchain address (e.g., a public key or derived thereof) associated with a smart contract. Digital assets may include assets such as cryptographic currency (e.g., bitcoin tokens), or other cryptographic tokens, such as a non-fungible token (NFT). In accordance with smart contract 616, contribution 608 may cause execution of the smart contract 616 (e.g., execution of code of the smart contract 616). For example, smart contract 616 may vend a token that can be provided to server (not shown in FIG. 6) which contributes its private key to a 2-of-2 signature scheme which can then be used to unlock review 610. Smart contract 616 may cause server to provide a private key which can then decrypt an encrypted version of review 610 encoded in the smart contract 616. Review 610 may be transmitted to viewer 602 as a result of execution of smart contract 616. In some examples, viewer 602 is provided with a token or other cryptographic information that enables the viewer 602 to access or otherwise view review 610. In various embodiments, if viewer 602 provides contribution 608 to blockchain ledger 604 that does not satisfy one or more conditions of smart contract 616 to access review 610, the smart contract 616 provides an indication to the viewer 602 that the contribution 608 is not sufficient and access to the review 610 is denied; the viewer 602 may then provide additional contributions such that the one or more conditions of the smart contract 616 are satisfied to access the review 610.

Author 606 may obtain contribution 608 (e.g., control of one or more digital assets associated with contribution 608) by obtaining ciphertext of private key SK-X from smart contract 616, decrypting the ciphertext using private key SK-A 612, and then providing an attestation of control of SK-X 614—for example, generating and broadcasting a digital signature (e.g., to blockchain ledger 604) using private key SK-X 614 which causes contribution 608 to be transferred to author 606. Smart contract 616 may include code that, upon receipt of an attestation of control of SK-X 614 (e.g., through a digital signature generated based on SK-X 614), causes one or more digital assets of contribution 608 to be transferred to author 606. Contribution 608 may be transferred to author 606 from a blockchain address (e.g., a public key or derived thereof) to a blockchain address of the author 606 (e.g., a wallet address of the author 606).

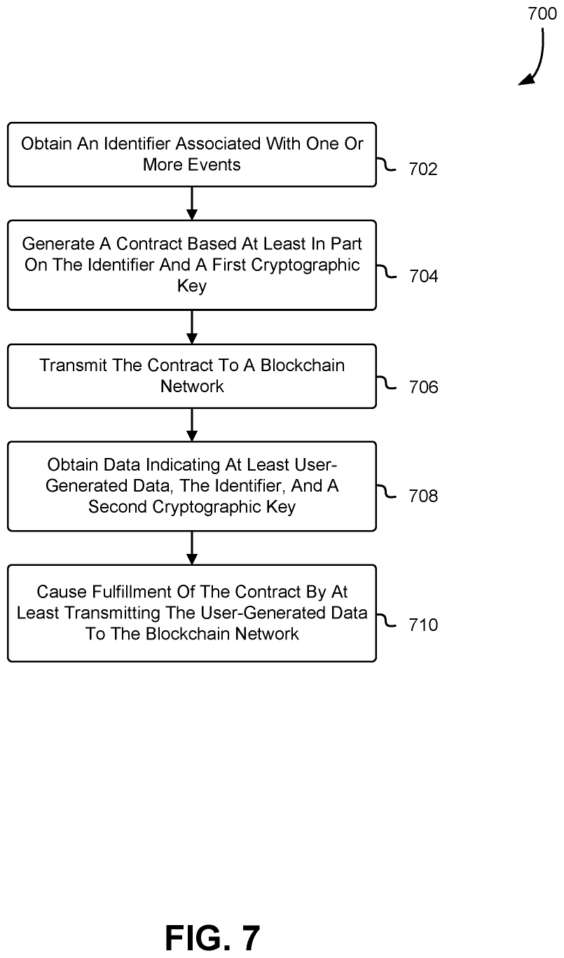

FIG. 7 illustrates an example of a process 700 to generate and process a smart contract, according to at least one embodiment. In at least one embodiment, some or all of process 700 (or any other processes described herein, or variations and/or combinations thereof) is performed under control of one or more computer systems configured with computer-executable instructions and is implemented as code (e.g., computer-executable instructions, one or more computer programs, or one or more applications) executing collectively on one or more processors, by hardware, software, or combinations thereof. In at least one embodiment, code is stored on a computer-readable storage medium in form of a computer program comprising a plurality of computer-readable instructions executable by one or more processors. In at least one embodiment, a computer-readable storage medium is a non-transitory computer-readable medium. In at least one embodiment, at least some computer-readable instructions usable to perform process 700 are not stored solely using transitory signals (e.g., a propagating transient electric or electromagnetic transmission). In at least one embodiment, a non-transitory computer-readable medium does not necessarily include non-transitory data storage circuitry (e.g., buffers, caches, and queues) within transceivers of transitory signals. In at least one embodiment, process 700 is performed at least in part on a computer system such as those described elsewhere in this disclosure. In an embodiment, process 700 is performed by a server such as those described in connection with FIGS. 1-3.

In at least one embodiment, a system performing at least a part of process 700 includes executable code to obtain 702 an identifier associated with one or more events. The identifier may be associated with an off-chain event, on-chain event, and/or variations thereof. An off-chain event may refer to a real-world event involving an actor and a merchant, such as a transfer of goods in connection with various payment systems. An on-chain event may refer to an event involving an actor, a merchant, and a blockchain ledger, such as a transfer of goods in connection with one or more blockchain transactions. For example, an off-chain and/or on-chain event may encode a transaction between an actor and a merchant. An off-chain and/or on-chain event may include a series of events, an agreement between two parties, an agreement between multiple parties, and the like. An off-chain and/or on-chain event may be a unilateral event that occurs with the participation of only one party. An off-chain and/or on-chain event may be associated with an identifier. In some cases, a merchant may generate an identifier corresponding to an off-chain event and/or an on-chain event. The system may obtain the identifier from one or more actors and/or merchants.

In at least one embodiment, a system performing at least a part of process 700 includes executable code to generate 704 a contract based at least in part on the identifier and a first cryptographic key. The system may generate a cryptographic key pair comprising a private key and a public key. The system may generate the contract, also referred to as a smart contract, which encodes the first cryptographic key. The first cryptographic key may be a public key of a cryptographic key pair. The contract may encode the identifier or other information indicating an off-chain and/or on-chain event. The contract may be a data object that encodes a set of conditions for a transfer of digital assets. The system may provide a private key, also referred to as a second cryptographic key, to one or more actors and/or merchants.

In at least one embodiment, a system performing at least a part of process 700 includes executable code to transmit 706 the contract to a blockchain network. The system may transmit or otherwise broadcast the contract to the blockchain network. The blockchain network may form a blockchain ledger. Further information regarding a blockchain ledger can be found in the description of FIG. 1.

In at least one embodiment, a system performing at least a part of process 700 includes executable code to obtain 708 data indicating at least user-generated data, the identifier, and a second cryptographic key. The system may obtain the data from one or more actors. In some examples, the system obtains the data from one or more websites that are accessible to one or more actors. The data may comprise the user-generated data, which may be one or more reviews based on an off-chain and/or on-chain event. For example, the one or more reviews may be reviews of a product associated with a transaction corresponding to an off-chain and/or on-chain event. The identifier may identify an off-chain and/or on-chain event or a contract associated with an off-chain and/or on-chain event. The second cryptographic key may be a private key of a cryptographic key pair.

In at least one embodiment, a system performing at least a part of process 700 includes executable code to cause 710 fulfillment of the contract by at least transmitting the user-generated data to the blockchain network. The system may transmit the user-generated data and/or a cryptographic verification of the user-generated data, such as a digital signature. In some embodiments, the system uses a second cryptographic key to generate a digital signature for the user-generated data. In various embodiments, the system obtains a digital signature of the user-generated data from one or more actors.

The system may transmit the user-generated data and a digital signature to the blockchain network to cause fulfillment of the contract. The contract may encode a public key (e.g., a first cryptographic key) such that when the user-generated data is broadcast to the blockchain network, in order for the contract to be successfully executed (e.g., fulfilled), a digital signature (e.g., a digital signature generated using a private key corresponding to the public key) over the user-generated data must be validated using the public key encoded in the contract. The contract may be fulfilled completely by a transfer of digital assets to one or more actors.

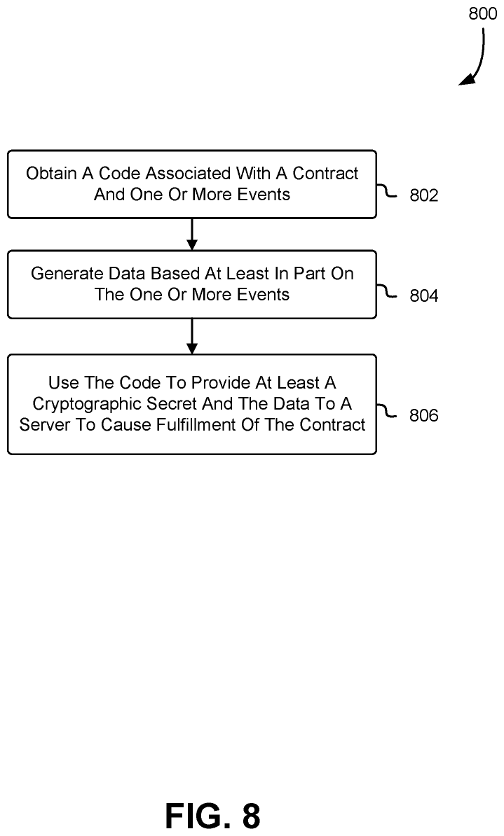

FIG. 8 illustrates an example of a process 800 to generate an authenticated review, according to at least one embodiment. In at least one embodiment, some or all of process 800 (or any other processes described herein, or variations and/or combinations thereof) is performed under control of one or more computer systems configured with computer-executable instructions and is implemented as code (e.g., computer-executable instructions, one or more computer programs, or one or more applications) executing collectively on one or more processors, by hardware, software, or combinations thereof. In at least one embodiment, code is stored on a computer-readable storage medium in form of a computer program comprising a plurality of computer-readable instructions executable by one or more processors. In at least one embodiment, a computer-readable storage medium is a non-transitory computer-readable medium. In at least one embodiment, at least some computer-readable instructions usable to perform process 800 are not stored solely using transitory signals (e.g., a propagating transient electric or electromagnetic transmission). In at least one embodiment, a non-transitory computer-readable medium does not necessarily include non-transitory data storage circuitry (e.g., buffers, caches, and queues) within transceivers of transitory signals. In at least one embodiment, process 700 is performed at least in part on a computer system such as those described elsewhere in this disclosure. In an embodiment, process 800 is performed by a computing device of an actor such as those described in connection with FIGS. 1-3.

In at least one embodiment, a system performing at least a part of process 800 includes executable code to obtain 802 a code associated with a contract and one or more events. The system may be part of one or more off-chain and/or on-chain events. The system may be a party in one or more transactions with one or more merchants. A server may, based on one or more off-chain and/or on-chain events, generate the contract, which may be a smart contract, and provide a secret to one or more merchants. The secret may be encoded in the code and provided to the system. The code may be a quick response (QR) code, barcode, or any suitable machine-readable optical label that encodes information. The code may be any suitable sequence of characters that may encode or otherwise represent cryptographic information, such as a cryptographic key.

In at least one embodiment, a system performing at least a part of process 800 includes executable code to generate 804 data based at least in part on the one or more events. The system may generate the data comprising one or more reviews of various aspects of the one or more events. For example, the one or more events includes a transaction in connection with an item, in which the data comprises one or more reviews of the item. In some examples, the data comprises information not associated with items and/or transactions. The data may include collections of text corresponding to any suitable entity, such as a location, object, event, item, transaction, and the like.

In at least one embodiment, a system performing at least a part of process 800 includes executable code to use 806 the code to provide at least a cryptographic secret and the data to a server to cause fulfillment of the contract. The system may extract the cryptographic secret from the code, and provide the cryptographic secret and the data to the server. In some examples, the system accesses one or more web interfaces (e.g., a website) using the code, and causes the one or more web interfaces to provide the cryptographic secret and the data to the server. The server may obtain the data and the cryptographic secret, and broadcast the data and either the cryptographic secret or cryptographic material generated based at least in part on the cryptographic secret (e.g., a digital signature) to a blockchain network to cause fulfillment of the contract. The contract may be fulfilled completely by a transfer of digital assets to the system (e.g., to a wallet address associated with the system).

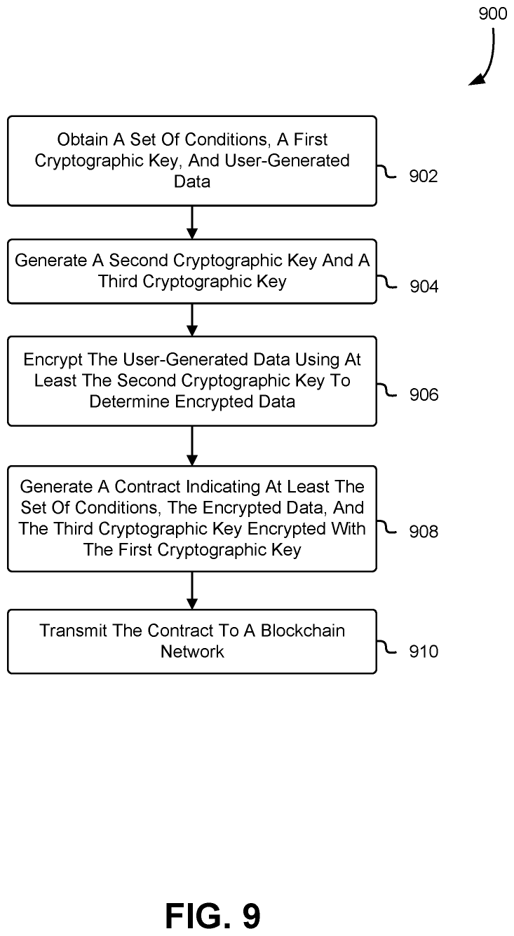

FIG. 9 illustrates an example of a process 900 to generate a private review, according to at least one embodiment. In at least one embodiment, some or all of process 900 (or any other processes described herein, or variations and/or combinations thereof) is performed under control of one or more computer systems configured with computer-executable instructions and is implemented as code (e.g., computer-executable instructions, one or more computer programs, or one or more applications) executing collectively on one or more processors, by hardware, software, or combinations thereof. In at least one embodiment, code is stored on a computer-readable storage medium in form of a computer program comprising a plurality of computer-readable instructions executable by one or more processors. In at least one embodiment, a computer-readable storage medium is a non-transitory computer-readable medium. In at least one embodiment, at least some computer-readable instructions usable to perform process 900 are not stored solely using transitory signals (e.g., a propagating transient electric or electromagnetic transmission). In at least one embodiment, a non-transitory computer-readable medium does not necessarily include non-transitory data storage circuitry (e.g., buffers, caches, and queues) within transceivers of transitory signals. In at least one embodiment, process 900 is performed at least in part on a computer system such as those described elsewhere in this disclosure. In an embodiment, process 900 is performed by a server such as those described in connection with FIGS. 4-6.

In at least one embodiment, a system performing at least a part of process 900 includes executable code to obtain 902 a set of conditions, a first cryptographic key, and user-generated data. The system may obtain the set of conditions, the first cryptographic key, and the user-generated data from one or more authors, also referred to as actors. The set of conditions may include conditions for accessing the user-generated data, such as a price on access to the data, one or more actions required for access to the data, and/or variations thereof. The first cryptographic key may be a public key of a public-private key pair. The user-generated data may be data generated by one or more authors based on one or more events.

In at least one embodiment, a system performing at least a part of process 900 includes executable code to generate 904 a second cryptographic key and a third cryptographic key. The system may generate a public-private cryptographic key pair comprising a public key and a private key. The second cryptographic key may correspond to the public key and the third cryptographic key may correspond to the private key. The system may generate or otherwise obtain cryptographic keys through any suitable manner, such as accessing one or more key management services, through one or more key derivation functions, and/or variations thereof.

In at least one embodiment, a system performing at least a part of process 900 includes executable code to encrypt 906 the user-generated data using at least the second cryptographic key to determine encrypted data. The system may encrypt the user-generated data using a public key of a public-private cryptographic key pair. The system may encrypt the user-generated data using the cryptographic key in one or more cryptographic ciphers to determine the encrypted data.

In at least one embodiment, a system performing at least a part of process 900 includes executable code to generate 908 a contract indicating at least the set of conditions, the encrypted data, and the third cryptographic key encrypted with the first cryptographic key. The system may encrypt the third cryptographic key, which may be a private key of a public-private cryptographic key pair, with the first cryptographic key, which may be a public key managed by one or more authors. The contract, also referred to as a smart contract, may be a data object that encodes the set of conditions, the encrypted data, and the encrypted third cryptographic key. In some examples, a cryptographic hash of the user-generated data and/or the encrypted data is included in the contract.

In at least one embodiment, a system performing at least a part of process 900 includes executable code to transmit 910 the contract to a blockchain network. The system may transmit the contract to one or more nodes of the blockchain network. The system may transmit or otherwise broadcast the contract to the blockchain network that may implement a distributed ledger; further information regarding a blockchain ledger can be found in the description of FIG. 1.

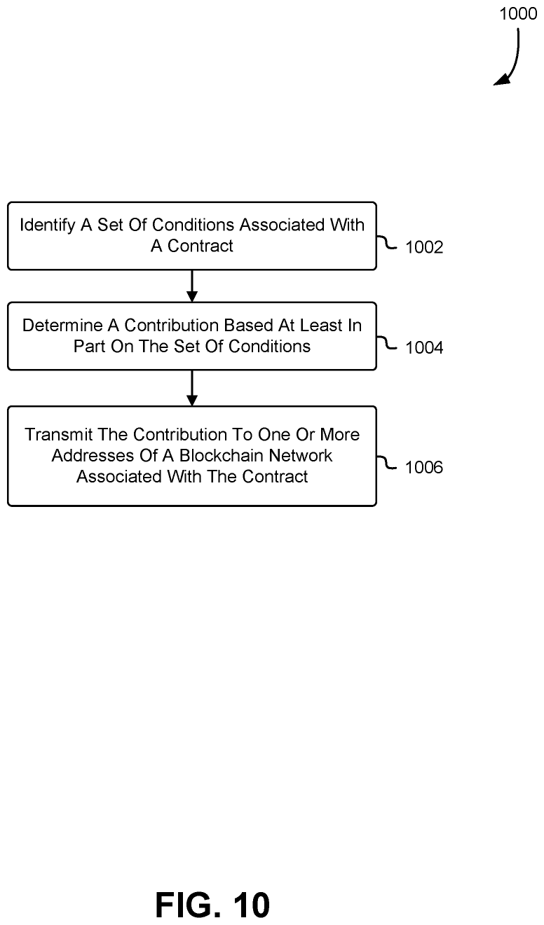

FIG. 10 illustrates an example of a process 1000 to view a private review, according to at least one embodiment. In at least one embodiment, some or all of process 1000 (or any other processes described herein, or variations and/or combinations thereof) is performed under control of one or more computer systems configured with computer-executable instructions and is implemented as code (e.g., computer-executable instructions, one or more computer programs, or one or more applications) executing collectively on one or more processors, by hardware, software, or combinations thereof. In at least one embodiment, code is stored on a computer-readable storage medium in form of a computer program comprising a plurality of computer-readable instructions executable by one or more processors. In at least one embodiment, a computer-readable storage medium is a non-transitory computer-readable medium. In at least one embodiment, at least some computer-readable instructions usable to perform process 1000 are not stored solely using transitory signals (e.g., a propagating transient electric or electromagnetic transmission). In at least one embodiment, a non-transitory computer-readable medium does not necessarily include non-transitory data storage circuitry (e.g., buffers, caches, and queues) within transceivers of transitory signals. In at least one embodiment, process 1000 is performed at least in part on a computer system such as those described elsewhere in this disclosure. In an embodiment, process 1000 is performed by a computing device of a viewer such as those described in connection with FIGS. 4-6.

In at least one embodiment, a system performing at least a part of process 1000 includes executable code to identify 1002 a set of conditions associated with a contract. The contract may refer to a smart contract that encodes data (e.g., user-generated data, such as a review) and the set of conditions. The contract may also encode one or more wallet addresses. The set of conditions may indicate conditions for access to data of the contract. For example, the set of conditions may include a condition of a requirement of a contribution to a particular wallet address. The system may identify the set of conditions by accessing or otherwise viewing the contract via a blockchain network.

In at least one embodiment, a system performing at least a part of process 1000 includes executable code to determine 1004 a contribution based at least in part on the set of conditions. The contribution may be control of a digital asset such as a cryptographic token. The set of conditions may indicate constraints for the contribution, such as a type of asset, amount of asset, and the like. The system may obtain, generate, or otherwise determine the contribution such that the contribution is in accordance with constraints indicated by the set of conditions.

In at least one embodiment, a system performing at least a part of process 1000 includes executable code to transmit 1006 the contribution to one or more addresses of a blockchain network associated with the contract. The one or more addresses may include one or more wallet addresses associated with the contract. The system may transmit the contribution to one or more wallet addresses associated with the contract via one or more transactions (e.g., blockchain transactions). Data associated with the contract, such as user-generated data (e.g., a review) may be provided to the system as a result of execution of the contract. The contract may successfully execute if the contribution is sufficient (e.g., satisfies one or more conditions of the contract), in which data associated with the contract (e.g., user-generated data, such as a review) may be transmitted to the system to be viewed or otherwise accessed.

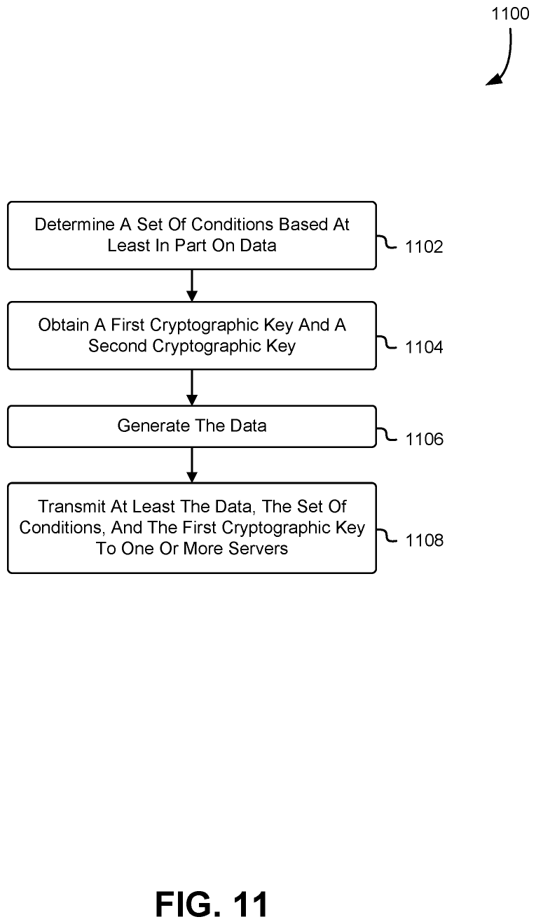

FIG. 11 illustrates an example of a process 1100 to obtain contributions in connection with a private review, according to at least one embodiment. In at least one embodiment, some or all of process 1100 (or any other processes described herein, or variations and/or combinations thereof) is performed under control of one or more computer systems configured with computer-executable instructions and is implemented as code (e.g., computer-executable instructions, one or more computer programs, or one or more applications) executing collectively on one or more processors, by hardware, software, or combinations thereof. In at least one embodiment, code is stored on a computer-readable storage medium in form of a computer program comprising a plurality of computer-readable instructions executable by one or more processors. In at least one embodiment, a computer-readable storage medium is a non-transitory computer-readable medium. In at least one embodiment, at least some computer-readable instructions usable to perform process 1100 are not stored solely using transitory signals (e.g., a propagating transient electric or electromagnetic transmission). In at least one embodiment, a non-transitory computer-readable medium does not necessarily include non-transitory data storage circuitry (e.g., buffers, caches, and queues) within transceivers of transitory signals. In at least one embodiment, process 1100 is performed at least in part on a computer system such as those described elsewhere in this disclosure. In an embodiment, process 1100 is performed by a computing device of an author such as those described in connection with FIGS. 4-6.

In at least one embodiment, a system performing at least a part of process 1100 includes executable code to determine 1102 a set of conditions based at least in part on data. The data may be user-generated data, such as a review, based on one or more off-chain and/or on-chain events. The set of conditions may comprise conditions of access to the data. The set of conditions may be obtained from one or more entities, such as one or more users, actors, authors, or any suitable entity. The set of conditions may include conditions such as one or more actions required to access the data.

In at least one embodiment, a system performing at least a part of process 1100 includes executable code to obtain 1104 a first cryptographic key and a second cryptographic key. The system may generate or otherwise obtain a public-private cryptographic key pair. In some examples, the system obtains a public-private cryptographic key pair from one or more cryptographic key management systems. The first cryptographic key may correspond to a public key of a public-private cryptographic key pair. The second cryptographic key may correspond to a private key of a public-private cryptographic key pair.

In at least one embodiment, a system performing at least a part of process 1100 includes executable code to generate 1106 the data. The system may generate the data based on input from one or more users, actors, authors, or any suitable entity. The system may utilize input from one or more entities to generate the data encoding the input. The data may include user-generated data based on one or more off-chain and/or on-chain events. For example, the system receives a review of an item of a transaction corresponding to an off-chain and/or on-chain event, in which the system generates the data to include the review.

In at least one embodiment, a system performing at least a part of process 1100 includes executable code to transmit 1108 at least the data, the set of conditions, and the first cryptographic key to one or more servers. The one or more servers may generate a contract (e.g., a smart contract) based at least in part on the data, the set of conditions, and the first cryptographic key, and broadcast the contract to a blockchain network. The one or more servers may use the first cryptographic key to encrypt a private key, and encode the encrypted private key in a contract.

A contract may be fulfilled through one or more contributions from one or more entities (e.g., viewers). The one or more contributions may satisfy various conditions of the contract to cause the contract to execute. The system may obtain the one or more contributions by obtaining an encrypted private key of the contract, decrypting the encrypted private key using a private key of the system (e.g., the second cryptographic key), and then providing an attestation of control of the private key of the contract, such as through a digital signature using the private key of the contract, which may cause the one or more contributions to be transferred to the system. The one or more contributions may be transferred to the system through a blockchain address of the system, such as one or more wallet addresses.

FIG. 12 is an illustrative, simplified block diagram of a computing device 1200 that can be used to practice at least one embodiment of the present disclosure. In various embodiments, the computing device 1200 may be used to implement any of the systems illustrated and described above. For example, the computing device 1200 may be configured for use as a data server, a web server, a portable computing device, a personal computer, or any electronic computing device. As shown in FIG. 12, the computing device 1200 may include one or more processors 1202 that, in embodiments, communicate with and are operatively coupled to a number of peripheral subsystems via a bus subsystem. In some embodiments, these peripheral subsystems include a storage subsystem 1206, comprising a memory subsystem 1208 and a file/disk storage subsystem 1210, one or more user interface input devices 1212, one or more user interface output devices 1214, and a network interface subsystem 1216. Such storage subsystem 1206 may be used for temporary or long-term storage of information.

In some embodiments, the bus subsystem 1204 may provide a mechanism for enabling the various components and subsystems of computing device 1200 to communicate with each other as intended. Although the bus subsystem 1204 is shown schematically as a single bus, alternative embodiments of the bus subsystem utilize multiple buses. The network interface subsystem 1216 may provide an interface to other computing devices and networks. The network interface subsystem 1216 may serve as an interface for receiving data from and transmitting data to other systems from the computing device 1200. In some embodiments, the bus subsystem 1204 is utilized for communicating data such as details, search terms, and so on.

In some embodiments, the user interface input devices 1212 includes one or more user input devices such as a keyboard; pointing devices such as an integrated mouse, trackball, touchpad, or graphics tablet; a scanner; a barcode scanner; a touch screen incorporated into the display; audio input devices such as voice recognition systems, microphones; and other types of input devices. In general, use of the term “input device” is intended to include all possible types of devices and mechanisms for inputting information to the computing device 1200. In some embodiments, the one or more user interface output devices 1214 include a display subsystem, a printer, or non-visual displays such as audio output devices, etc. In some embodiments, the display subsystem includes a cathode ray tube (CRT), a flat-panel device such as a liquid crystal display (LCD), light emitting diode (LED) display, or a projection or other display device. In general, use of the term “output device” is intended to include all possible types of devices and mechanisms for outputting information from the computing device 1200. The one or more user interface output devices 1214 can be used, for example, to present user interfaces to facilitate user interaction with applications performing processes described and variations therein, when such interaction may be appropriate.

In some embodiments, the storage subsystem 1206 provides a computer-readable storage medium for storing the basic programming and data constructs that provide the functionality of at least one embodiment of the present disclosure. The applications (programs, code modules, instructions), when executed by one or more processors in some embodiments, provide the functionality of one or more embodiments of the present disclosure and, in embodiments, are stored in the storage subsystem 1206. These application modules or instructions can be executed by the one or more processors 1202. In various embodiments, the storage subsystem 1206 additionally provides a repository for storing data used in accordance with the present disclosure. In some embodiments, the storage subsystem 1206 comprises a memory subsystem 1208 and a file/disk storage subsystem 1210.

In embodiments, the memory subsystem 1208 includes a number of memories, such as a main random access memory (RAM) 1218 for storage of instructions and data during program execution and/or a read only memory (ROM) 1220, in which fixed instructions can be stored. In some embodiments, the file/disk storage subsystem 1210 provides a non-transitory persistent (non-volatile) storage for program and data files and can include a hard disk drive, a floppy disk drive along with associated removable media, a Compact Disk Read Only Memory (CD-ROM) drive, an optical drive, removable media cartridges, or other like storage media.

In some embodiments, the computing device 1200 includes at least one local clock 1222. The at least one local clock 1222, in some embodiments, is a counter that represents the number of ticks that have transpired from a particular starting date and, in some embodiments, is located integrally within the computing device 1200. In various embodiments, the at least one local clock 1222 is used to synchronize data transfers in the processors for the computing device 1200 and the subsystems included therein at specific clock pulses and can be used to coordinate synchronous operations between the computing device 1200 and other systems in a data center. In another embodiment, the local clock is a programmable interval timer.

The computing device 1200 could be of any of a variety of types, including a portable computer device, tablet computer, a workstation, or any other device described below. Additionally, the computing device 1200 can include another device that, in some embodiments, can be connected to the computing device 1200 through one or more ports (e.g., USB, a headphone jack, Lightning connector, etc.). In embodiments, such a device includes a port that accepts a fiber-optic connector. Accordingly, in some embodiments, this device is that converts optical signals to electrical signals that are transmitted through the port connecting the device to the computing device 1200 for processing. Due to the ever-changing nature of computers and networks, the description of the computing device 1200 depicted in FIG. 12 is intended only as a specific example for purposes of illustrating the preferred embodiment of the device. Many other configurations having more or fewer components than the system depicted in FIG. 12 are possible.

It should be noted that the phrase “one-way function” includes functions that are not necessarily one-way in the strict mathematical sense, but that exhibit properties (such as collision resistance, preimage resistance and second preimage resistance) that render the function useful in contexts in which the various techniques of the present disclosure are applied. In this manner, an entity with output of the function but without access to the corresponding input, is unable to determine the input without, for instance, extraordinary expenditure of computational resources necessary for a cryptographic (e.g., brute force) attack. One-way functions (also referred to as “effectively one-way functions”) include, but are not limited to, cryptographic hash functions such as message authentication codes, (e.g., keyed-hash based message authentication code (HMAC)), key derivation functions, such as PBKDF2 and bcrypt (with the password being based at least in part on the plaintext and the cryptographic key), and other secure randomization functions which may, but do not necessarily, have a domain (set of possible inputs) that is larger than their range (possible outputs). Other suitable functions (referred to as “f”) for various embodiments include, but are not limited to, functions that take at least a plaintext and cryptographic key as input and that have a property of preimage resistance (given a value y, the probability of randomly generating an input x such that f(x)=y is below a specified threshold), second preimage resistance (given an input x1, the probably of randomly generating another input x2, different from x1, such that f(x1)=f(x2) is below a specified threshold) and/or collision resistance (the probability of two different inputs resulting in the same output is less than a specified threshold). The exact threshold for each probability may be context-dependent, with lower probabilities corresponding to higher security contexts. Hash functions usable as one-way functions in accordance with the techniques of the present disclosure include, but are not limited to, functions described in the National Institute of Standards and Technology (NIST) Special Publication 800-107, Revision 1 “Recommendation for Applications Using Approved Hash Algorithms,” which is incorporated by reference herein.

The specification and drawings are, accordingly, to be regarded in an illustrative rather than a restrictive sense. However, it will be evident that various modifications and changes may be made thereunto without departing from the scope of the invention as set forth in the claims. Likewise, other variations are within the scope of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions and equivalents falling within the scope of the invention, as defined in the appended claims.

The use of the terms “a” and “an” and “the” and similar referents in the context of describing the disclosed embodiments (especially in the context of the following claims) is to be construed to cover both the singular and the plural, unless otherwise indicated or clearly contradicted by context. The terms “comprising,” “having,” “including” and “containing” are to be construed as open-ended terms (i.e., meaning “including, but not limited to,”) unless otherwise noted. The term “connected,” when unmodified and referring to physical connections, is to be construed as partly or wholly contained within, attached to or joined together, even if there is something intervening. Recitation of ranges of values in the present disclosure are merely intended to serve as a shorthand method of referring individually to each separate value falling within the range unless otherwise indicated and each separate value is incorporated into the specification as if it were individually recited. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., could be either A or B or C, or any nonempty subset of the set of A and B and C. For instance, in the illustrative example of a set having three members, the conjunctive phrases “at least one of A, B, and C” and “at least one of A, B, and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. Further, unless stated otherwise or otherwise clear from context, the phrase “based on” means “based at least in part on” and not “based solely on.”

Operations of processes described can be performed in any suitable order unless otherwise indicated or otherwise clearly contradicted by context. Processes described (or variations and/or combinations thereof) can be performed under the control of one or more computer systems configured with executable instructions and can be implemented as code (e.g., executable instructions, one or more computer programs or one or more applications) executing collectively on one or more processors, by hardware or combinations thereof. In some embodiments, the code can be stored on a computer-readable storage medium, for example, in the form of a computer program comprising a plurality of instructions executable by one or more processors. In some embodiments, the computer-readable storage medium is non-transitory.

The use of any and all examples, or exemplary language (e.g., “such as”) provided, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described, including the best mode known to the inventors for carrying out the invention. Variations of those embodiments will become apparent to those of ordinary skill in the art upon reading the foregoing description. The inventors expect skilled artisans to employ such variations as appropriate and the inventors intend for embodiments of the present disclosure to be practiced otherwise than as specifically described. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated or otherwise clearly contradicted by context.

All references, including publications, patent applications, and patents, cited are hereby incorporated by reference to the same extent as if each reference were individually and specifically indicated to be incorporated by reference and were set forth in its entirety.

What is claimed is:

1. A computer-implemented method, comprising:
obtaining an identifier associated with one or more events;
generating a smart contract based at least in part on the identifier and a first cryptographic key;
transmitting the smart contract to a blockchain network;
obtaining data indicating at least user-generated data, the identifier, and a second cryptographic key; and
causing fulfillment of the smart contract by at least transmitting the user-generated data to the blockchain network.

2. The computer-implemented method of claim 1, wherein the first cryptographic key and the second cryptographic key are a public-private cryptographic key pair.

3. The computer-implemented method of claim 2, further comprising performing one or more digital signature operations on the user-generated data based at least in part on the second cryptographic key.

4. The computer-implemented method of claim 1, wherein the user-generated data is generated based at least in part on the one or more events.

5. A system, comprising one or more non-transitory machine-readable media having stored thereon a set of instructions, which if performed by one or more processors, cause the system to at least:
obtain a code associated with a contract and one or more events;
generate data based at least in part on the one or more events; and
use the code to provide at least a cryptographic secret and the data to a server to cause fulfillment of the contract.

6. The system of claim 5, wherein the code is a quick response (QR) code.

7. The system of claim 6, wherein the set of instructions further include instructions, which if performed by the one or more processors, cause the system to at least extract the cryptographic secret based at least in part on the QR code.

8. The system of claim 6, wherein the cryptographic secret is a private cryptographic key.

9. The system of claim 5, wherein the set of instructions further include instructions, which if performed by the one or more processors, cause the system to at least:
access an interface based at least in part on the code; and
cause the interface to provide the data and the cryptographic secret to the server.

10. The system of claim 5, wherein the set of instructions further include instructions, which if performed by the one or more processors, cause the system to at least obtain one or more assets as a result of the fulfillment of the contract.

11. The system of claim 5, wherein the data comprises one or more reviews based on the one or more events.

12. The system of claim 5, wherein the code is a barcode.

13. A non-transitory computer-readable storage medium having stored thereon executable instructions that, as a result of being executed by one or more processors of a computer system, cause the computer system to at least:
generate a contract encoding one or more conditions based at least in part on one or more events;
transmit the contract to one or more nodes of a blockchain network;
obtain data from one or more actors generated based on the one or more conditions and the one or more events; and
transmit at least the data to the one or more nodes of the blockchain network.

14. The non-transitory computer-readable storage medium of claim 13, wherein the executable instructions further include instructions that, as a result of being executed by the one or more processors of the computer system, cause the computer system to at least:
generate a cryptographic secret; and
provide the cryptographic secret to the one or more actors.

15. The non-transitory computer-readable storage medium of claim 14, wherein the contract encodes at least a public cryptographic key corresponding to the cryptographic secret.

16. The non-transitory computer-readable storage medium of claim 14, wherein the executable instructions further include instructions that, as a result of being executed by the one or more processors of the computer system, cause the computer system to at least:
obtain the cryptographic secret with the data from the one or more actors;
generate a digital signature based at least in part on the data and the cryptographic secret; and
transmit the digital signature to the one or more nodes of the blockchain network.

17. The non-transitory computer-readable storage medium of claim 14, wherein the cryptographic secret is a private cryptographic key.

18. The non-transitory computer-readable storage medium of claim 13, wherein the one or more conditions include conditions for a transfer of one or more assets.

19. The non-transitory computer-readable storage medium of claim 13, wherein the executable instructions further include instructions that, as a result of being executed by the one or more processors of the computer system, cause the computer system to at least:
obtain a digital signature from the one or more actors; and
transmit the digital signature to the one or more nodes of the blockchain network

20. The non-transitory computer-readable storage medium of claim 13, wherein the data comprises one or more reviews generated by the one or more actors based at least in part on the one or more events.
